(19) United States
(12) Patent Application Publication
(10) Pub. No.: US 2005/0196586 A1
(43) Pub. Date: Sep. 8, 2005

(54) Enhanced porous ceramic article and method of manufacturing the same

(75) Inventors: Takanao Shimodaira, Nagoya-city (JP); Michihiro Asai, Nagoya-city (JP)

Correspondence Address: PARKHURST & WENDEL, L.L.P., 1421 PRINCE STREET, SUITE 210, ALEXANDRIA, VA, 22314-2805, US

(73) Assignee: NGK Insulators, Ltd., Nagoya-city (JP)

(21) Appl. No.: 11/067,709

(22) Filed: Mar. 1, 2005

(30) Foreign Application Priority Data
Mar. 2, 2004 (JP) 2004-057386

(51) Int. Cl. B32B 3/12

(52) U.S. Cl. 428/116; 428/117

(57) ABSTRACT

A method of manufacturing an enhanced porous ceramic article includes the steps of: impregnating (a) a porous ceramic body, (b) a first porous body having one or more dried layers of porous ceramic films on a surface of a porous ceramic body, or (c) a second porous body having one or more dried-fired layers of porous ceramic films on a surface of a porous ceramic body, with inorganic oxide sol; sending air to a desired portion of the porous ceramic body and/or the porous ceramic films to aggregating and drying inorganic oxide particles in the inorganic oxide sol inside a surface of the desired portion; and thereafter firing the body or the body with the film to obtain the enhanced porous ceramic article. The manufacturing method is capable of substantially uniformly aggregating and supporting inorganic oxide such as silica in a desired portion of the porous ceramic article for use in a ceramic filter or the like.

### BACKGROUND OF THE INVENTION

1. Field of the Invention

The present invention relates to an enhanced porous ceramic article for use in a ceramic filter or the like, and a method of manufacturing the article.

2. Description of the Related Art

In recent years, ceramic filters using porous ceramic articles have been broadly used as filters for solid-liquid separation or gas-solid separation (see, e.g., JP-A-2000-153117). The ceramic filters have been preferably used in removing suspension materials, bacteria, powder dust and the like in liquid or gas in broad fields such as water purification treatment, exhaust gas treatment, medical and food field, because the filters are superior in physical strength, durability, resistance to corrosion and the like as compared with organic polymer films for use in similar application.

The ceramic filter usually has a structure in which a porous ceramic article having a honeycomb shape including a large number of channels (cells) partitioned by partition walls is used as a substrate, and one or more layers of porous ceramic films are formed on the surface of the substrate (cell inner peripheral surface). In many cases, the porous ceramic film is formed by bonding aggregate particles formed of ceramic such as alumina by a vitreous bonding material, or self-sintering the aggregate particles, and pore diameters are adjusted in such a manner as to successively decrease toward the surface-layer film from the substrate.

A fluid to be treated supplied into the cells of the ceramic filter is filtered by the porous ceramic films, and thereafter flows out to an external space through pores of the substrate. However, when the fluid to be treated is supplied into the cells, the fluid to be treated directly flows into the filter from pores in a partition wall end portion of a filter end face, and flows to the outside without being filtered by the porous ceramic films. To prevent this, in the end face of the ceramic filter, the end portions of the substrate (partition wall portion) and porous ceramic films are sealed with a sealing material such as glass in some case. FIG. 10 is a partially enlarged sectional view showing a state of the end portion seal. The end portions of a substrate (partition wall portion) 1 which is a porous ceramic article, and an intermediate film 3 and a filter film 5 which are porous ceramic films are sealed in such a manner as to be covered with a sealing material 11. It is to be noted that FIG. 10 shows an example of a ceramic filter having a double-layer film structure in which two layers of porous ceramic films (intermediate film 3 and filter film 5) are formed. A method of sealing the end portion is also similar in a ceramic filter having a single-layer film structure including one layer of the porous ceramic film.

To eliminate clogging by dirt, the ceramic filter used in a water purification treatment or the like is periodically cleaned by chemicals. In this case, it is general to alternately use, for example, an aqueous alkaline solution such as an aqueous sodium hypochlorite solution for removing an organic content, and an aqueous acid solution such as an aqueous citric acid solution for removing an inorganic content in the cleaning chemicals, and therefore the filter has been required to have resistances to corrosions with respect to acid and alkali. Especially when the filter end portion is sealed as described above, the porous ceramic film in the vicinity of the filter end portion is sometimes required to have a resistance to corrosion higher than that of another portion because the cleaning chemicals are easily accumulated in the vicinity of the end portion seal.

Then, in order to enhance the resistance to corrosion of the filter end portion, a method has been tried in which before application of the sealing material, the filter end portion is immersed in silica sol, and the end portions of the substrate and porous ceramic films are impregnated with silica sol, and naturally dried, so that the end portions of the porous ceramic films contain silica (SiO₂).

However, in the above-described natural drying of silica sol with which the end portions of the substrate and porous ceramic films are impregnated, progress of the drying easily fluctuates in an end face direction of the filter. Moreover, when there are fluctuations in the progress of the drying in this manner, silica particles in silica sol tend to aggregate in a portion where the drying proceeds fast in the process of the drying. Therefore, conversely, an only small amount of silica particles are contained in a portion where the drying proceeds slowly, and the resistance to corrosion with respect to the cleaning chemicals cannot be sufficiently secured in the portion. It is to be noted that even when not only the end portion of the porous ceramic film but also the whole film are impregnated with silica sol, and naturally dried, fluctuations are similarly generated in the progress of the drying, and a portion having an insufficient resistance to corrosion is generated.

### SUMMARY OF THE INVENTION

The present invention has been developed in view of the conventional situations, and an object thereof is to provide a method of manufacturing an enhanced porous ceramic article, capable of substantially uniformly aggregating and supporting inorganic oxide such as silica in a desired portion of a porous ceramic article for use in a ceramic filter or the like, and an enhanced porous ceramic article obtained by the manufacturing method, in which inorganic oxide is substantially uniformly aggregated and supported in a predetermined portion.

According to the first aspect of the present invention, there is provided a method of manufacturing an enhanced porous ceramic article, comprising the steps of:
impregnating (a) a porous ceramic body, (b) a first porous body having one or more dried layers of porous ceramic films on a surface of a porous ceramic body, or (c) a second porous body having one or more dried-fired layers of porous ceramic films on a surface of a porous ceramic body, with inorganic oxide sol;
sending air to a desired portion of the porous ceramic body and/or the porous ceramic films to aggregating and drying inorganic oxide particles in the inorganic oxide sol inside a surface of the desired portion; and thereafter firing the body or the body with the film to obtain the enhanced porous ceramic article.

Moreover, according to the second aspect of the present invention, there is provided a method of manufacturing an enhanced porous ceramic article, comprising the steps of:
impregnating (a) a porous ceramic body, (b) a first porous body having one or more dried layers of porous ceramic films on a surface of a porous ceramic body, or (c) a second porous body having one or more dried-fired layers of porous ceramic films on a surface of a porous ceramic body, with inorganic oxide sol;
heating a desired portion of the porous ceramic body and/or the porous ceramic films to aggregating and drying inorganic oxide particles in the inorganic oxide sol inside a surface of the desired portion; and thereafter firing the body or the body with the film to obtain the enhanced porous ceramic article.

Furthermore, according to the third aspect of the present invention, there is provided an enhanced porous ceramic article comprising:
a porous ceramic body, or one or more layers of porous ceramic films on the surface of the porous ceramic body; and
inorganic oxide aggregated and supported inside a surface of a predetermined portion of the porous ceramic body.

According to the method of manufacturing the enhanced porous ceramic article of the present invention, inorganic oxide can be substantially uniformly aggregated and supported in the desired portion of the porous ceramic body or the porous ceramic film formed on the surface of the porous ceramic body. In the enhanced porous ceramic article of the present invention, since inorganic oxide is aggregated and supported inside the surface of the predetermined portion or in the pores of the predetermined portion of the porous ceramic film formed on the surface of the body, a property of the portion is improved, and a specific property is imparted to the portion. For example, in a case where the enhanced porous ceramic article is used in a ceramic filter, the portion on which inorganic oxide such as silica is aggregated/supported exerts a high resistance to corrosion with respect to chemicals for cleaning the filter.

### BRIEF DESCRIPTION OF THE DRAWINGS

FIG. 1 is a partially enlarged sectional view of an end portion of a ceramic filter;

FIG. 2 is a partially enlarged sectional view showing a state in which end portions of a substrate, an intermediate film, and a filter film are impregnated with inorganic oxide sol;

FIG. 3 is a partially enlarged sectional view showing a state in which impregnated inorganic oxide sol is blown/dried;

FIG. 4 is a partially enlarged sectional view showing a distribution state of blown/dried inorganic oxide particles;

FIG. 5 is a partially enlarged sectional view showing a state in which the blown/dried end portions of the substrate, intermediate film, and filter film are sealed with a vitreous sealing material;

FIG. 6 is an explanatory view showing a silica amount measurement position in an example and comparative example;

FIG. 7 is an explanatory view showing a silica amount measurement portion in the example and comparative example;

FIG. 8 is a graph showing results of the example;

FIG. 9 is a graph showing results of the comparative example; and

FIG. 10 is a partially enlarged sectional view showing a state of an end portion seal of the ceramic filter.

### DESCRIPTION OF THE PREFERRED EMBODIMENT

The first aspect of the present invention includes three manufacturing method (first, second and third manufacturing methods), the second aspect of the present invention includes three manufacturing method (fourth, fifth and sixth manufacturing methods) described below. The third aspect of the present invention includes two porous ceramic article (first and second porous ceramic article).

Preferred Embodiments of the present invention will be described hereinafter.

According a first manufacturing method of the present invention, a porous ceramic body is impregnated with inorganic oxide sol, and air is sent to a desired portion of the porous ceramic body. Accordingly, inorganic oxide particles in the inorganic oxide sol are aggregated and dried inside a surface of the desired portion, and thereafter the body is fired to obtain an enhanced porous ceramic article.

In this manufacturing method, first the porous ceramic body is immersed in the inorganic oxide sol to thereby impregnate the porous ceramic body with the inorganic oxide sol. Subsequently, air is sent to the desired portion of the porous ceramic body impregnated with the inorganic oxide sol using an air blower such as a fan. The drying of the inorganic oxide sol in a portion on which the sent air strikes proceeds faster than another portion. However, the inorganic oxide particles in the inorganic oxide sol tend to aggregate in a portion which dries fast. Therefore, in a distribution state of the inorganic oxide particles after the drying, the particles are aggregated inside the surface of a portion to which the air has been blown. Moreover, when the article is fired, the enhanced porous ceramic article is obtained including inorganic oxide fixed/supported and aggregated/supported inside the surface.

When this manufacturing method is used, inorganic oxide can be substantially uniformly aggregated and supported in the desired portion of the porous ceramic article. Therefore, for example, when a ceramic filter constituted of the porous ceramic article is prepared, it is possible to prepare an enhanced porous ceramic article in which inorganic oxide such as silica is aggregated/supported especially in the end portion to be given a resistance to corrosion with respect to chemicals for cleaning the filter.

According to a second manufacturing method of the present invention, one or more layers of porous ceramic films are formed and dried on the surface of a porous ceramic body, thereafter the body and/or the film(s) are impregnated with inorganic oxide sol, and air is sent to the surface of a desired portion of the porous ceramic film. Accordingly, inorganic oxide particles in the inorganic oxide sol are aggregated and dried inside the film of the desired portion of the porous ceramic film, and thereafter the porous ceramic body with the film is fired to obtain an enhanced porous ceramic article. As an example of the embodiment of the manufacturing method, an example in manufacturing a ceramic filter will be described hereinafter with reference to the drawings.

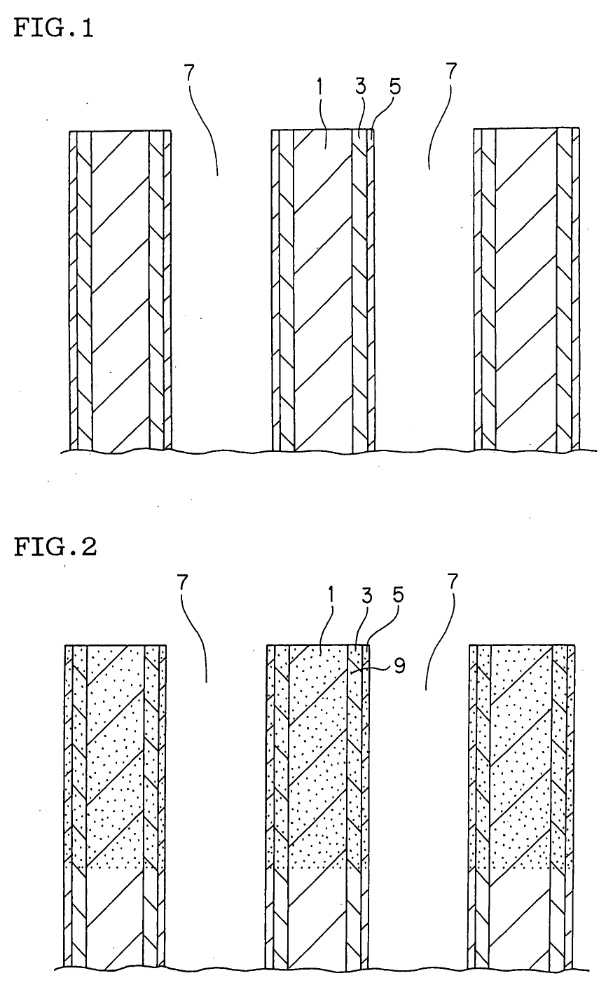

FIG. 1 is a sectional view partially enlarging and showing an end portion of the ceramic filter. When manufacturing a honeycomb filter, a honeycomb-shaped porous ceramic body having a plurality of cells (through holes) 7 partitioned by porous partition walls is used as a substrate 1 of the filter. First, an intermediate film 3 is formed on an inner peripheral surface (partition wall surface) of the cell 7, and further a filter film 5 is formed on the surface of the intermediate film 3.

For example, slurry for the intermediate film, containing ceramic particles such as alumina (Al₂O₃) particles, and a vitreous bonding material is poured into the cell 7 of the substrate 1, and attached to the cell inner peripheral surface to form the intermediate film 3. For example, slurry for the filter film, containing ceramic particles such as titania (TiO₂) particles is poured into the cell on which the intermediate film has been formed, and attached to the surface of the intermediate film to form the filter film 5. The intermediate film 3 formed as described above is finally fired to constitute a porous film in which the ceramic particles are bonded to one another with the vitreous bonding material. The filter film 5 is similarly finally fired to thereby constitute a porous film in which the particles are bonded to one another by self-sintering of the ceramic particles. Pore diameters of the intermediate film and filter film can be controlled by particle diameters of the ceramic particles for use.

After these formed porous ceramic films are dried, for example, as shown in FIG. 2, a portion in a predetermined range from an end face of the filter is immersed in the inorganic oxide sol to thereby impregnate the portion with the inorganic oxide sol. At this time, inorganic oxide particles 9 in the inorganic oxide sol are substantially uniformly distributed in the impregnated portion.

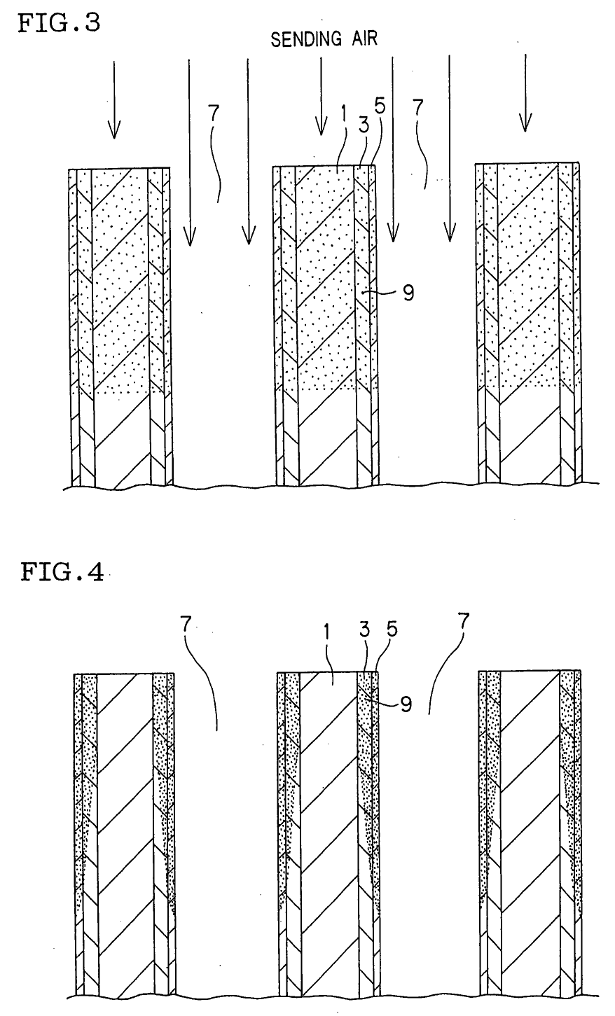

Next, as shown in FIG. 3, air is sent into the cells 7 from an end-face side of the ceramic filter using an air blower (not shown) such as a fan, and the inorganic oxide sol is dried while applying the air to the intermediate film 3 and filter film 5 formed on the inner peripheral surface of the cell 7 in the vicinity of the filter end portion. As described above, the drying of the inorganic oxide sol in a portion on which the sent air strikes proceeds faster than another portion, and the inorganic oxide particles 9 in the inorganic oxide sol tend to aggregate. Therefore, as shown in FIG. 4, in a distribution state of the inorganic oxide particles 9 after the drying, the particles are aggregated inside the intermediate film 3 and filter film 5 in the vicinity of the filter end portion to which the air has been sent. Moreover, by the firing of the filter, a ceramic filter is obtained in which inorganic oxide is supported in a fixed manner, and aggregated/supported in the films.

When the manufacturing method is used, the inorganic oxide can be aggregated and supported in the film of the desired portion of the porous ceramic film formed on the surface of the porous ceramic article. Therefore, for example, in a case where the ceramic filter is prepared as in the above-described example, it is possible to prepare a ceramic filter in which inorganic oxide such as silica is aggregated/supported in the porous ceramic film in the vicinity of the end portion which is to be especially given the resistance to corrosion with respect to the chemicals for cleaning the filter, so that the resistance to corrosion is enhanced.

Moreover, when the inorganic oxide sol is dried while sending air into the cells 7 from the end-face side of the filter as in the present invention described in the above-described example, fluctuations in the progress of the drying in a filter end-face direction are reduced, and the whole end face can be dried at a substantially uniform speed as compared with a case where the sol has heretofore been dried by natural drying. Therefore, fluctuations of distribution of inorganic oxide particles in the filter end face direction are suppressed, and the resistance to corrosion is not partially insufficient.

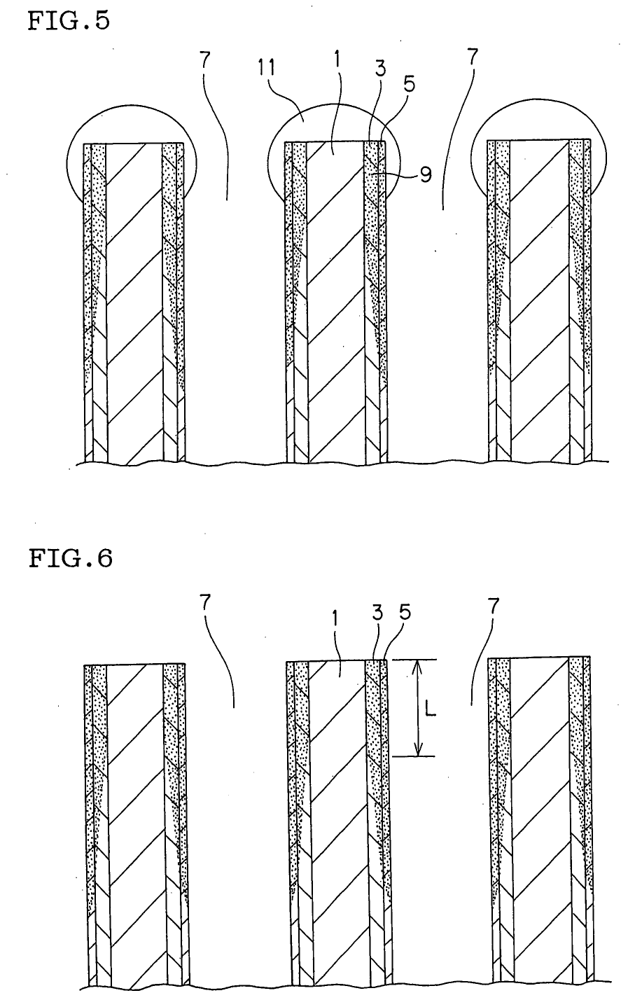

It is to be noted that in the ceramic filter, as shown in FIG. 5, the end portions of the substrate (partition wall portion) 1 and porous ceramic films (intermediate film 3 and filter film 5) are sometimes sealed by the sealing material 11 in the end face of the filter. However, for example, a slurried sealing material can be applied to the filter end portion by a method such as spray coating, and fired to form the sealed portion.

When the end portion is sealed for use, in the ceramic filter described above in the example, a content of inorganic oxide derived from the inorganic oxide sol in a range of 5 mm from the end face of the intermediate film 3 is preferably 20% by mass or more with respect to a total amount of aggregate particles and inorganic oxide in the range in order to secure the resistance to corrosion with respect to the cleaning chemicals which easily remain in the vicinity of the sealed portion.

In a third manufacturing method of the present invention, one or more layers of porous ceramic films are formed, dried, and fired on the surface of a porous ceramic body, thereafter the body and/or the film(s) are impregnated with inorganic oxide sol, and air is sent to the surface of a desired portion of the porous ceramic film. Accordingly, inorganic oxide particles in the inorganic oxide sol are aggregated and dried inside the film of the desired portion of the porous ceramic film, and thereafter the body with the film is fired again to obtain an enhanced porous ceramic article.

This method is similar to the second manufacturing method except that the body with the film is fired once, and the formed porous ceramic film is immobilized to a certain degree before the body and/or the film(s) are impregnated with the inorganic oxide sol, and function/effect is also basically the same.

In a fourth manufacturing method of the present invention, a porous ceramic body is impregnated with inorganic oxide sol, and a desired portion of the porous ceramic body is heated. Accordingly, inorganic oxide particles in the inorganic oxide sol are aggregated and dried inside a surface of the desired portion, and thereafter the body is fired to obtain an enhanced porous ceramic article.

This method is similar to the first manufacturing method except that after impregnating the porous ceramic body with the inorganic oxide sol, the desired portion is heated instead of sending the air to the desired portion of the porous ceramic body. Even when the desired portion is heated, the progress of the drying of the heated portion can be accelerated in the same manner as in the sending of the air. Therefore, the function/effect similar to that of the first manufacturing method is obtained. The desired portion of the porous ceramic body can be heated using heating means such as an electric heater.

In a fifth manufacturing method of the present invention, after one or more layers of porous ceramic films are formed and dried on the surface of a porous ceramic body, the body and/or the film(s) are impregnated with inorganic oxide sol, the surface of a desired portion of the porous ceramic film is heated, accordingly inorganic oxide particles in the inorganic oxide sol are aggregated and dried inside the film of the desired portion of the porous ceramic film, and thereafter the body with the film is fired to obtain an enhanced porous ceramic article.

This method is similar to the second manufacturing method except that after impregnating the body and/or the film(s) with the inorganic oxide sol, the surface of the desired portion is heated instead of sending the air to the surface of the desired portion of the porous ceramic film. Even when the surface of the desired portion of the porous ceramic film is heated, the progress of the drying of the heated portion can be accelerated in the same manner as in the sending of the air. Therefore, the function/effect similar to that of the second manufacturing method is obtained. The surface of the desired portion of the porous ceramic film can be heated using heating means such as an electric heater.

In a sixth manufacturing method of the present invention, one or more layers of porous ceramic films are formed, dried, and fired on the surface of a porous ceramic body, thereafter the body and/or the film(s) are impregnated with inorganic oxide sol, and the surface of a desired-portion of the porous ceramic film is heated. Accordingly inorganic oxide particles in the inorganic oxide sol are aggregated and dried inside the film of the desired portion of the porous ceramic film, and thereafter the body with the film is fired again to obtain an enhanced porous ceramic article.

This method is similar to the fifth manufacturing method except that the body with the film is fired, and the formed porous ceramic film is immobilized to a certain degree before the body and/or the film(s) are impregnated with the inorganic oxide sol, and the function/effect is also basically the same.

As described above, in the manufacturing method of the present invention, a tendency that the inorganic oxide particles in the impregnated inorganic oxide sol are aggregated in a portion in which the drying proceeds fast is utilized. The inorganic oxide particles are aggregated inside the surface of the desired portion of the porous ceramic body, or in the film of the desired portion of the porous ceramic film formed on the surface of the porous ceramic body. A porous ceramic article is manufactured in which property of the portion is improved, a specific property is imparted to the portion, and the resistance to corrosion is enhanced, for example, with respect to the chemicals for cleaning the ceramic filter.

The inorganic oxide sol for use in the first to sixth manufacturing methods of the present invention may be appropriately selected in accordance with a property to be imparted to the porous ceramic body or the porous ceramic film on the surface of the body. For example, when an enhanced porous ceramic article is used as the ceramic filter for purifying water, and the resistance to corrosion against the chemicals for cleaning the filter is to be imparted, any of silica sol, titania sol, and alumina sol is preferably used.

Moreover, a portion in which the inorganic oxide particles are aggregated by air sending or heating is not especially limited, and the inorganic oxide particles can be appropriately aggregated in the desired portion in accordance with application or specification environment of the enhanced porous ceramic article.

The shape of the porous ceramic article is not especially limited, and, in addition to general honeycomb shapes, various shapes of the porous ceramic articles may be used as the shapes of the ceramic filters. The manufacturing method of the present invention can be preferably used as the method of manufacturing the ceramic filter superior in the resistance to corrosion of the end portion or the like, but, needless to say, the present invention is also applicable to the method of manufacturing the enhanced porous ceramic article for use in another application.

In a first enhanced porous ceramic article of the present invention, inorganic oxide is aggregated and supported inside a surface of a predetermined portion of the body. The enhanced porous ceramic article can be manufactured, for example, by the first or fourth manufacturing methods. In the portion in which inorganic oxide is aggregated inside the surface, the property of the portion is improved, or a specific property is imparted to the portion by the aggregated inorganic oxide. For example, an enhanced porous ceramic article in which inorganic oxide such as silica is aggregated/supported inside the surface of a predetermined portion such as an end portion is used in the ceramic filter for purifying water. In this case, the predetermined portion exerts high resistance to corrosion with respect to the chemicals for cleaning the filter.

A second enhanced porous ceramic article of the present invention is a porous ceramic body on whose surface one or more layers of porous ceramic films are formed, and inorganic oxide is aggregated and supported in pores of a predetermined portion of the porous ceramic film. The enhanced porous ceramic article can be manufactured, for example, by the second, third, fifth, and sixth manufacturing methods. In the portion in which inorganic oxide is aggregated in the pores of the porous ceramic film, the property of the portion is improved, or a specific property is imparted to the portion by the aggregated inorganic oxide. For example, an enhanced porous ceramic article in which inorganic oxide such as silica is aggregated/supported inside the film of a predetermined portion such as an end portion of the porous ceramic film is used in the ceramic filter for purifying water. In this case, the predetermined portion of the porous ceramic film exerts high resistance to corrosion with respect to the chemicals for cleaning the filter.

The inorganic oxide aggregated in the predetermined portion in the first or second enhanced porous ceramic article of the present invention may be appropriately selected in accordance with a property to be imparted to the porous ceramic body or the porous ceramic film on the surface of the body. For example, when the enhanced porous ceramic article is used as the ceramic filter for purifying water, and the resistance to corrosion against the chemicals for cleaning the filter is to be imparted, any of silica, titania, and alumina is preferably used.

Moreover, the portion in which inorganic oxide is aggregated/supported is not especially limited, and inorganic oxide may be appropriately aggregated in a necessary portion in accordance with application or specification environment of the enhanced porous ceramic article. For example, the enhanced porous ceramic article is used in the ceramic filter for purifying water, whose end portion is sealed by the sealing material. In this case, since the chemicals for cleaning the filter easily remain in the vicinity of the end portion, inorganic oxide such as silica is preferably aggregated/supported inside the surface layer in the vicinity of the end portion of the porous ceramic body, or in the pores in the vicinity of the end portion of the porous ceramic film formed on the surface of the porous ceramic body.

The shape of the porous ceramic article is not especially limited, and, in addition to general honeycomb shapes, various shapes of the porous ceramic articles may be used as the shapes of the ceramic filters. The enhanced porous ceramic article of the present invention can be preferably used as the ceramic filter superior in the resistance to corrosion of the end portion or the like, but, needless to say, the present invention is also usable in another application.

### EXAMPLES

The present invention will be described hereinafter in further detail with reference to examples, but the present invention is not limited to these examples.

### Example

A porous ceramic body (diameter: 180 mm, length: 1000 mm, cell density: 8 cells/cm², partition wall thickness: 0.65 mm, average pore diameter: 10 μm) formed of alumina and having a honeycomb shape was used as a substrate. Alumina particles (average particle diameter: 3 μm) which were aggregate materials, and a vitreous bonding material formed of silicate glass were mixed at a mass ratio of 100:14, and water was added to thereby obtain slurry for an intermediate film. The slurry was poured in the cells of the substrate, and attached to cell inner peripheral surfaces to form the intermediate film. This film was fired at 950° C. for three hours, the intermediate film was fixed, and thereafter water was added to titania particles (average particle diameter: 0.5 μm) to thereby obtain slurry for a filter film. The slurry was poured in the cells of the substrate, and attached to the surface of the intermediate film to form the filter film. This film was again fired at 950° C. for three hours, the filter film was fixed, and a ceramic filter was obtained.

An end portion of the ceramic filter was immersed in silica sol (silica particle diameter: 60 nm, solid content concentration: 20 mass %), and filter end portions (end portions of the substrate, intermediate film, and filter film) were impregnated with about 100 g of silica sol in the whole end face. Next, a fan was used in environment at room temperature and humidity, and silica sol with which the end portion was impregnated was dried from an end face side of the ceramic filter while sending air into the cells at a wind velocity of 2 m/s.

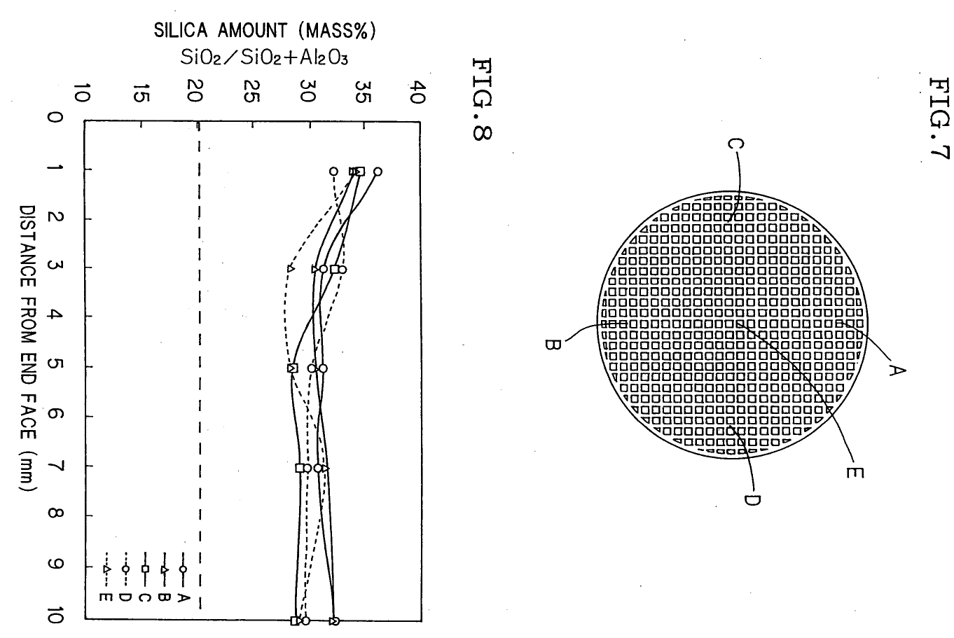

After the drying, the filter was fired at 950° C. for three hours, and as to the fired ceramic filter, a silica content (=SiO₂/(SiO₂+Al₂O₃)) in the intermediate film was measured in a position having a distance L of 1 to 10 mm from the end face shown in FIG. 6. The measurement was performed with respect to a part of the partition wall cut as each of five portions A to E on the filter end face shown in FIG. 7. Results are shown in a graph of FIG. 8, and it has been confirmed that 20 mass % or more of silica is contained in all positions in a range of a distance L up to 10 mm from the end face in the intermediate film. Substantially similar results are obtained in all the five portions A to E on the filter end face, and distribution of silica in a filter end face direction was also substantially uniform.

### Comparative Example

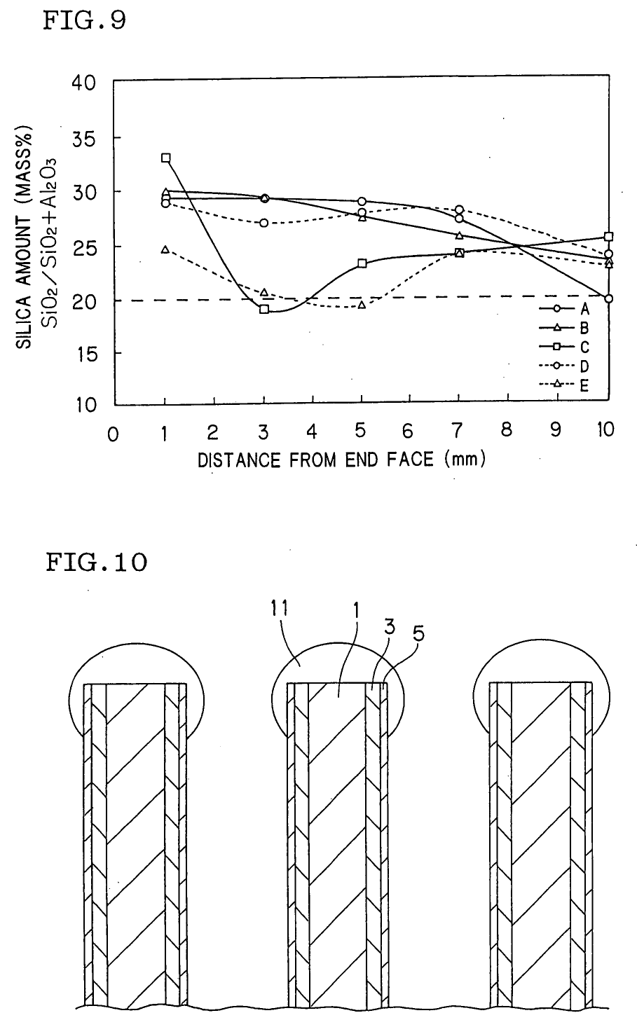

A ceramic filter containing silica in an end portion thereof was obtained in the same manner as in the above-described example except that any air was not sent at the time of drying of impregnated silica sol, and the sol was naturally dried, and a silica content was measured in the same manner as in the example. Results are shown in a graph of FIG. 9. In two portions C, E among five portions A to E on a filter end face, portions whose silica contents were less than 20 mass % existed in a range of 5 mm from the end face, and a distribution of silica in a filter end face direction was also non-uniform.

The present invention is preferably usable as a ceramic filter which needs to be periodically cleaned with chemicals, such as a ceramic filter for purifying water, or a method of manufacturing the filter.

1. A method of manufacturing an enhanced porous ceramic article, comprising the steps of:
impregnating (a) a porous ceramic body, (b) a first porous body having one or more dried layers of porous ceramic films on a surface of a porous ceramic body, or (c) a second porous body having one or more dried-fired layers of porous ceramic films on a surface of a porous ceramic body, with inorganic oxide sol;
sending air to a desired portion of the porous ceramic body and/or the porous ceramic films to aggregating and drying inorganic oxide particles in the inorganic oxide sol inside a surface of the desired portion; and thereafter firing the body or the body with the film to obtain the enhanced porous ceramic article.

2. The method of manufacturing the enhanced porous ceramic article according to claim 1, wherein the inorganic oxide sol is one of silica sol, titania sol, and alumina sol.

3. The method of manufacturing the enhanced porous ceramic article according to claim 1, wherein the enhanced porous ceramic article is a honeycomb-shaped porous ceramic article.

4. The method of manufacturing the enhanced porous ceramic article according to claim 1, for use as a method of manufacturing a ceramic filter.

5. A method of manufacturing an enhanced porous ceramic article, comprising the steps of:
impregnating (a) a porous ceramic body, (b) a first porous body having one or more dried layers of porous ceramic films on a surface of a porous ceramic body, or (c) a second porous body having one or more dried-fired layers of porous ceramic films on a surface of a porous ceramic body, with inorganic oxide sol;
heating a desired portion of the porous ceramic body and/or the porous ceramic films to aggregating and drying inorganic oxide particles in the inorganic oxide sol inside a surface of the desired portion; and thereafter firing the body or the body with the film to obtain the enhanced porous ceramic article.

6. The method of manufacturing the enhanced porous ceramic article according to claim 5, wherein the inorganic oxide sol is one of silica sol, titania sol, and alumina sol.

7. The method of manufacturing the enhanced porous ceramic article according to claim 5, wherein the enhanced porous ceramic article is a honeycomb-shaped porous ceramic article.

8. The method of manufacturing the enhanced porous ceramic article according to claim 5, for use as a method of manufacturing a ceramic filter.

9. An enhanced porous ceramic article comprising:
a porous ceramic body, or one or more layers of porous ceramic films on the surface of the porous ceramic body; and
inorganic oxide aggregated and supported inside a surface of a predetermined portion of the porous ceramic body.

10. The enhanced porous ceramic article according to claim 9, wherein the inorganic oxide is one of silica, titania, and alumina.

11. The enhanced porous ceramic article according to claim 9, comprising: a honeycomb-shaped porous ceramic article.

12. The enhanced porous ceramic article according to claim 9, comprising: a ceramic filter.
